(19) United States
(12) Patent Application Publication
(10) Pub. No.: US 2023/0003843 A1
(43) Pub. Date: Jan. 5, 2023

(54) TRANSMISSION UNIT AND LIDAR DEVICE WITH OPTICAL HOMOGENIZER

(71) Applicant: Robert Bosch GmbH, Stuttgart (DE)

(72) Inventors: Albert Groening, Stuttgart (DE); Andre Albuquerque, Penalva do Castelo (PT); Anne Schumann, Korntal-Muenchingen (DE); Dionisio Pereira, Avintes (PT); Stefan Spiessberger, Weinstadt (DE)

(21) Appl. No.: 17/780,870

(22) PCT Filed: Nov. 16, 2020
(86) PCT No.: PCT/EP2020/082189

§ 371 Date: May 27, 2022

(30) Foreign Application Priority Data
Dec. 17, 2019 (DE) 10 2019 219 825.2

(51) Int. Cl. G01S 7/481; G02B 27/09

(52) U.S. Cl. CPC G01S 7/4815; G02B 27/0961; G02B 27/0966; G02B 27/0927

(57) ABSTRACT

A transmission unit of a LIDAR device. The transmission unit includes at least one beam source for generating electromagnetic beams having a linear or rectangular cross section, and transmission optics. The transmission unit has an optical homogenizer which is arranged in a beam path of the generated beams in front of or behind the transmission optics and has at least one lens array. A LIDAR device is also described.

### FIELD

The present invention relates to a transmission unit of a LIDAR device, comprising at least one beam source for generating electromagnetic beams having a linear or rectangular cross section. Furthermore, the present invention relates to a LIDAR device having a transmission unit of this kind.

### BACKGROUND INFORMATION

Sensors, such as for example camera sensors, radar sensors and LIDAR sensors, are necessary for technically implementing automated driving functions. LIDAR sensors are used for example for creating accurate three-dimensional maps. For this purpose, LIDAR sensors have a pulsed laser and optical systems for forming the generated beams. Based on a time-of-flight analysis, distances between the LIDAR sensor and objects in the scanning area can be ascertained.

The maximum range of the LIDAR sensor is essentially restricted to the amount of light reflected from the scanning area which can still reliably be received and evaluated by a detector. One customary approach for increasing the range of a LIDAR sensor is to use stronger beam sources. In the vehicle sector, the usable radiated power of beam sources, such as for example lasers, is limited in order to ensure eye safety.

Different conventional methods for complying with the limit values of the radiated power for eye safety involve active object detection and can restrict the emitted radiated power as soon as a pedestrian or a road user is detected. Such methods are however dependent on reliable object detection, which can be prone to errors and thus dangerous to road users. Furthermore, complex detection algorithms and corresponding control methods for setting the radiated power are costly to implement technically.

### SUMMARY

An object underlying the present invention is to provide a transmission unit and a LIDAR device which provide a homogeneous beam distribution for scanning scanning areas and comply with the limit values of the radiated power with regard to eye safety.

This object may be achieved by means of the present invention. Advantageous configurations of the present invention are disclosed herein.

According to one aspect of the present invention, a transmission unit of a LIDAR device is provided. In accordance with an example embodiment of the present invention, the transmission unit comprises at least one beam source for generating electromagnetic beams having a linear or rectangular cross section, and transmission optics. According to the present invention, the transmission unit has an optical homogenizer which is arranged in a beam path of the generated beams in front of or behind the transmission optics and has at least one lens array.

The limit values with respect to eye safety are defined by a maximally permissible radiated power of the beam source per surface. The at least one beam source may for example be a laser or an LED. Usually a peak or an intensity maximum which may reach or exceed the limit value is produced in the generated beams. Using the optical homogenizer avoids such peaks in the distribution of the radiated power of the generated beams. The generated beams can thus have a flat or constant intensity distribution or radiated power distribution which does not contain any peaks.

The transmission unit may optionally include the transmission optics, which may consist for example of lenses, prisms and filters. Furthermore, further optical elements, micromirrors, macromirrors and the like may be provided depending on the configuration of the transmission unit. For example, the beam source may emit generated beams with a linear cross section which are swiveled by a movement of the transmission unit or a mirror along an axis in order to expose a scanning area.

By using the optical homogenizer, beams which have a constant or plateau-shaped intensity distribution in the close range can be provided for scanning the scanning area. As a result, the radiated power can be increased while simultaneously ensuring the limit values for eye safety. In such case, complex and actively controlled control mechanisms and detection mechanisms, which constitute an additional source of error, can be dispensed with. Despite the optimized intensity distribution of the beams emitted in the scanning area, the transmission unit can be configured in a technically simple manner and for example have only one optical element or the transmission optics.

According to one example embodiment of the present invention, the optical homogenizer includes two lens arrays spaced apart from each other and having a multiplicity of cylindrical microlenses, the cylindrical microlenses being each arranged on a surface of the lens arrays. Preferably image planes of the cylindrical microlenses are arranged on a focal plane within a spacing between the lens arrays.

In particular, the focal plane can be arranged centered between the two lens arrays and aligned parallel to a two-dimensional extent of the lens arrays.

The cylindrical microlenses of the two lens arrays preferably have the same alignment and run transversely to a direction of propagation of the generated beams. In particular, the cylindrical microlenses may form a one-dimensional array that is arranged on one side on each lens array. A second surface of the respective lens arrays may be formed flat.

Each cylindrical microlens of the first lens array can image the incoming generated beams on the focal plane. Each cylindrical microlens of the first lens array thus images the generated beams on the focal plane, the respective images of the cylindrical microlenses being superposed at least in regions.

The image plane of the cylindrical microlenses of the first lens array is preferably an object plane of the cylindrical microlenses of the second lens array. Thus a multiplicity of optical images of the beam source which have a vertical offset relative to each other are imaged on the focal plane. The cylindrical microlenses of the second lens array use the images on the focal plane as objects for renewed superposing imaging, and thus guarantee optimum uniformity of the beams.

According to one further specific embodiment of the present invention, the lens arrays of the optical homogenizer are arranged in such a way that the surfaces provided with the cylindrical microlenses are directed in the direction of the at embodiment, the lens arrays of the optical homogenizer are arranged in such a way that the surfaces provided with the cylindrical microlenses are directed toward or away from each other. These measures mean that the lens arrays can be arranged in a versatile manner, in order to achieve a homogeneous intensity distribution of the beams.

According to one further embodiment of the present invention, the optical homogenizer includes a lens array with a first surface and a second surface, with a multiplicity of cylindrical microlenses being arranged on the first surface and the second surface. Preferably the image planes of the cylindrical microlenses are arranged between the first surface and the second surface. As a result, a one-part optical homogenizer can be used. The lens array has a multiplicity of cylindrical microlenses in each case on both surfaces, the cylindrical microlenses of the respective surface of the lens array running parallel to each other. A one-part optical homogenizer means that the transmission unit can be configured in a technically particularly simple manner and require a minimal number of components.

The respective surfaces of the lens array point away from each other. Thus the cylindrical microlenses of the respective surfaces also point away from each other. The focal plane or the image planes of the cylindrical microlenses of the first surface preferably lie within the lens array, in particular in a center of the lens array. The cylindrical microlenses of the second surface are configured in such a way that they utilize the common image plane of the cylindrical microlenses of the first surface as the object plane. As a result, a particularly homogeneous intensity distribution for the beams to be emitted can be set.

According to one further specific embodiment of the present invention, the image planes of the cylindrical microlenses are set centrally between the first surface and the second surface.

As a result, the cylindrical microlenses of the second surface can use the distributed or superposed images of the beam source in order to provide a homogeneous intensity distribution. In particular, the cylindrical microlenses on both surfaces of the lens array may be configured the same, as a result of which the optical homogenizer can be produced in a particularly cost-efficient manner.

In a further configuration of the present invention, the transmission unit comprises a homogenization plane arranged in the region of the transmission optics.

According to a further embodiment of the present invention, the transmission optics are set up to form a linear illumination.

According to one further embodiment of the present invention, a number of the cylindrical microlenses, a form of the cylindrical microlenses and/or a size of the cylindrical microlenses of the lens arrays of the optical homogenizer is/are configured to be the same as each other or different from each other. Preferably the form of the cylindrical microlenses and/or the size of the cylindrical microlenses within one surface of the lens array is/are configured to be constant or varying. As a result, the number of the cylindrical microlenses, their size and their size distribution along a surface of a lens array can be varied in such a way that optical properties of the transmission unit are adapted to different fields of application.

In particular, the generated beams can be homogenized by the cylindrical microlenses along a direction transversely to the extent of the cylindrical microlenses.

According to one further specific embodiment of the present invention, the at least one beam source is configured as an array of emitters, the emitters being arranged in such a way that the beams generated by the beam source form a rectangular and/or elongate scanning pattern. In particular, the beam source may be configured as a one-dimensional or two-dimensional array of emitters. The emitters may in such case be surface emitters or so-called VCSELs or edge emitters. In particular, the emitters may be formed as LEDs or lasers. Furthermore, the emitters may be configured as fiber diode bars or as fiber lasers with planar waveguides or with a fiber splitter arrangement.

According to a further aspect of the present invention, a LIDAR device for scanning scanning areas is provided. The LIDAR device has a transmission unit according to the present invention and a receiving unit. The transmission unit of the LIDAR device has at least one radiation source for generating beams. The receiving unit has at least one detector for detecting beams.

The receiving unit may have receiving optics for receiving the beams back-scattered and/or reflected from the scanning area which then focus the received beams on the at least one detector. The detector may in such case be positioned in a focal plane of the receiving optics.

The at least one detector of the receiving unit may for example be configured as a CCD sensor, CMOS sensor, APD array, SPAD array and the like.

The LIDAR device may be configured as a flash LIDAR or a solid state LIDAR without moving components. Alternatively, the LIDAR device or parts of the LIDAR device may be configured to be rotatable or swivelable along at least one axis of rotation. Furthermore, the LIDAR device may optionally be a micro-scanner or a macro-scanner.

Below, preferred embodiments of the present invention will be discussed in greater detail with reference to greatly simplified schematic representations.

### BRIEF DESCRIPTION OF THE DRAWINGS

FIG. 1 shows a schematic representation of a LIDAR device according to one specific embodiment of the present invention.

FIG. 2 shows a sectional view of a two-part optical homogenizer, in accordance with an example embodiment of the present invention.

FIG. 3 shows a sectional view of a one-part optical homogenizer, in accordance with an example embodiment of the present invention.

FIG. 4 shows a perspective representation of the one-part optical homogenizer with an exemplary beam path, in accordance with an example embodiment of the present invention.

FIG. 5 shows a schematic intensity distribution of the beams within the plane E of FIG. 4 without an optical homogenizer, in accordance with an example embodiment of the present invention.

FIG. 6 shows a schematic intensity distribution of the beams within the plane E of FIG. 4 with an optical homogenizer, in accordance with an example embodiment of the present invention.

FIG. 7 shows a diagram illustrating a change in the intensity distribution due to the use of the optical homogenizer, in accordance with an example embodiment of the present invention.

### BRIEF DESCRIPTION OF THE DRAWINGS

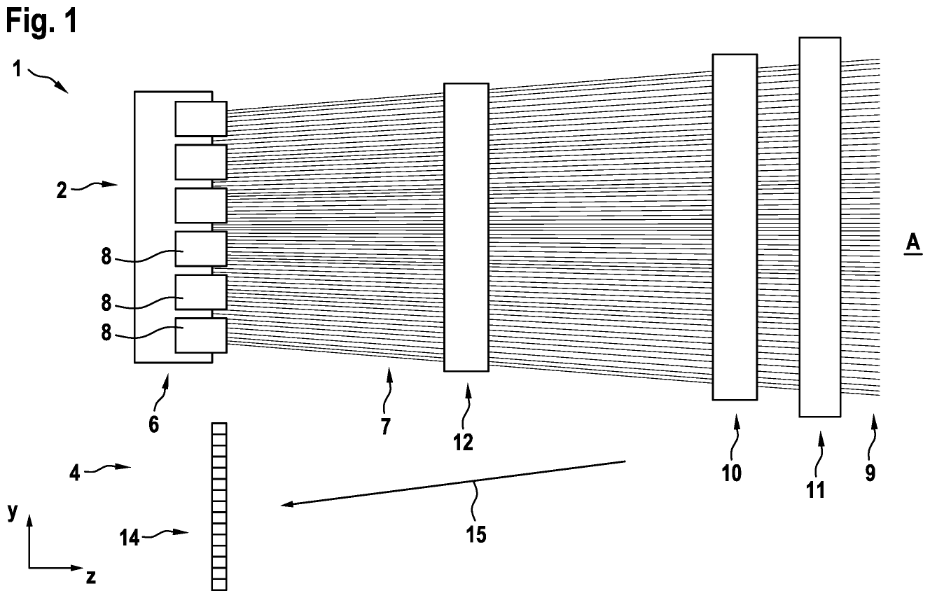

FIG. 1 shows a schematic representation of a LIDAR device 1 according to one specific embodiment. The LIDAR device 1 has a transmission unit 2 and a receiving unit 4.

The transmission unit 2 has a beam source 6 with a multiplicity of emitters 8. The emitters 8 in the example illustrated are configured as an array of surface emitters. The emitters 8 can emit generated beams 7 with a for example infrared wavelength range.

The beams 7 generated by the beam source 6 are bundled by transmission optics 10. The transmission optics 10 are formed as a cylindrical lens that extends in the vertical direction y and has the vertical direction y as its axis of rotation.

The beam source 6 generates beams 7 having a linear or cuboid cross section. The cross section of the beams 7 extends in an elongate manner along the vertical direction y. The generated beams 7 can be collimated by the transmission optics 10.

A further optical element 11 that is configured as a part of the transmission optics 10 can be used to take on the vertical beam shaping. The optical element 11 can likewise be configured as a microlens array or as a so-called honeycomb condenser.

In the beam path in front of the transmission optics 10 and 11 there is arranged an optical homogenizer 12. The optical homogenizer 12 is embodied by way of example as a one-part lens array and will be described in greater detail in the following figures. The optical homogenizer 12 generates beams with a more uniform intensity distribution compared with the generated beams 7, and makes homogeneous illumination approximately in the region of the optical element 11 or the transmission optics 10 possible.

The receiving unit 4 has a detector 14. The detector 14 can receive beams 15 reflected and/or back-scattered from the scanning area 1 and convert them into electrical measurement data.

Furthermore, the receiving unit 14 may have optional receiving optics that form the reflected and/or back-scattered beams 15 or focus them on the detector 14.

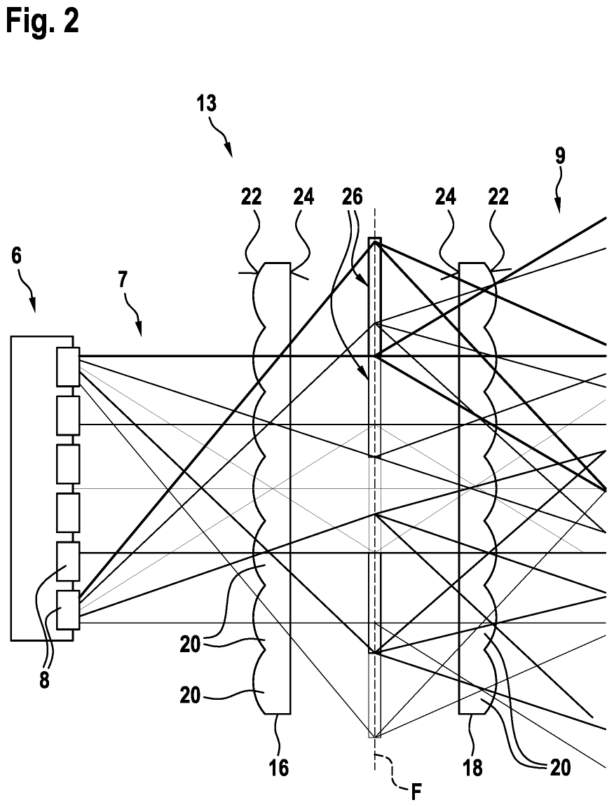

FIG. 2 shows a sectional view of a two-part optical homogenizer 13. The optical homogenizer 13 has a first lens array 16 and a second lens array 18. Each lens array 16, 18 has a multiplicity of cylindrical microlenses 20.

The cylindrical microlenses 20 are arranged on one surface 22 in each case of the respective lens arrays 16, 18. The cylindrical microlenses 20 run in a transverse direction x or transversely to the vertical direction y.

A surface 24 arranged in the opposite direction to the cylindrical microlenses 20 is formed flat or without further texturing or contouring. The lens arrays 16, 18 are aligned in such a way that the flat surfaces 24 face one another.

The generated beams 7 are focused by the respective cylindrical microlenses 20 of the first lens array 16 and imaged on a focal plane F. In particular, each cylindrical microlens 20 generates an image 26 on the focal plane F. The images 26 of the cylindrical microlenses 20 are imaged in the vertical direction y overlapped along the focal plane F.

The images 26 of the cylindrical microlenses 20 of the first lens array 16 are used as objects by the cylindrical microlenses 20 of the second lens array 18. Thus the already overlapped images 26 are focused anew and overlapped, producing a homogeneous intensity distribution of the resulting beams 9 that are emitted into the scanning area A.

The focal plane F in this case forms an image plane for the first lens array 16 and for the second lens array 18. The respective focal points of the cylindrical microlenses may preferably be arranged offset relative to the focal plane F.

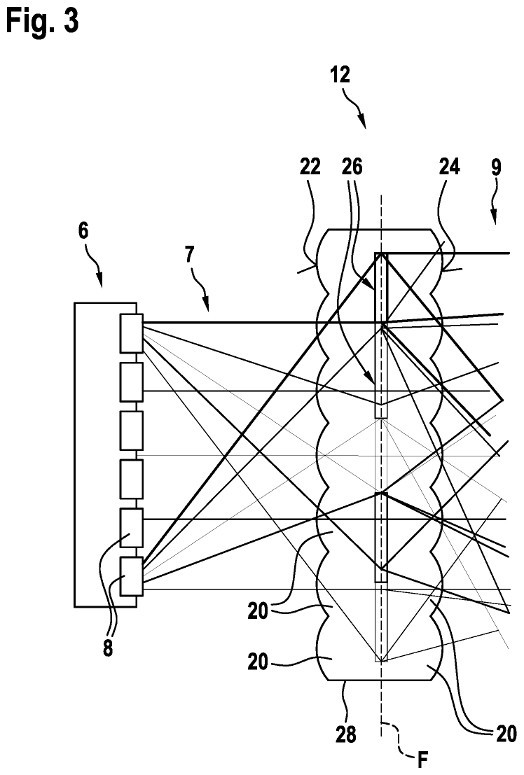

FIG. 3 shows a sectional view of a one-part optical homogenizer 12. Unlike the optical homogenizer 13 shown in

FIG. 2, this one is configured in one part. The one-part optical homogenizer 12 has a lens array 28 having a first surface 22 and a second surface 24.

The cylindrical microlenses 20 are arranged both on the first surface 22 and on the second surface 24. The cylindrical microlenses 20 of the respective surfaces 22, 24 have a common image plane that runs through the focal plane F.

In the example illustrated, the focal plane F runs in the direction of propagation z of the beams 7 centrally or in a centered manner through the lens array 28.

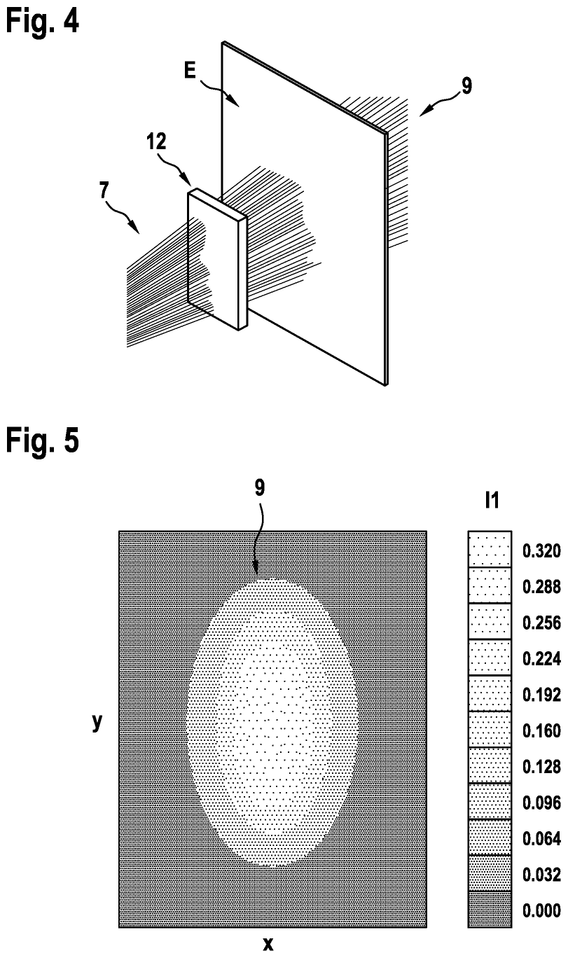

FIG. 4 shows a perspective representation of the one-part optical homogenizer 12 with an exemplary beam path. Furthermore, a plane E is illustrated which is used to illustrate the further figures. The plane E is arranged downstream from the optical homogenizer 12 and extends in an x-y plane that runs transversely to the direction of propagation z.

FIG. 5 shows a schematic intensity distribution I of the beams 9 emitted into the scanning area A within the plane E of FIG. 4 without the use of an optical homogenizer 12.

The beams 9 have a transverse intensity distribution I with a clearly marked peak. In particular, the intensity distribution I is essentially Gaussian.

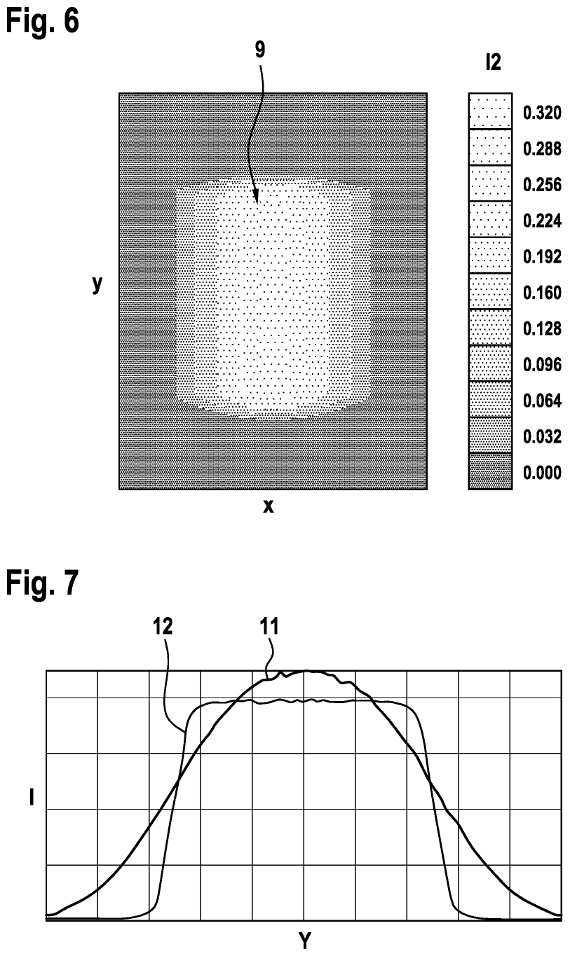

FIG. 6 shows a schematic intensity distribution I of the beams 9 within the plane E of FIG. 4 with an optical homogenizer 12 being used. In such case, a clear deviation from the Gaussian intensity distribution I of FIG. 5 can be recognized. The beams 9 have a homogenized intensity distribution I.

The difference between the intensity distribution Il of FIG. 5 and the intensity distribution 12 of FIG. 6 is illustrated in the diagram shown in FIG. 7.

The diagram shows an intensity I along the vertical direction y and illustrates the constant intensity curve 12 of the beams 9 that can be set by the optical homogenizer 12, 13.

In one advantageous manifestation of the present invention, one or more optical systems that bring the beams 7 into a desired form are located in the homogenization plane E. In the case of linear illumination, the at least one optical system may serve for collimation for producing low divergence in one direction in space and for producing fanning or a great divergence in the other direction in space.

1-11. (canceled)

12. A transmission unit of a LIDAR device, comprising:
at least one beam source configured to generate electromagnetic beams having a linear or rectangular cross section;
transmission optics; and
an optical homogenizer arranged in a beam path of the generated beams in front of or behind the transmission optics, including at least one lens array.

13. The transmission unit as recited in claim 12, wherein the transmission unit includes a homogenization plane arranged in a region of the transmission optics.

14. The transmission unit as recited in claim 12, wherein the optical homogenizer includes two lens arrays spaced apart from each other and having a multiplicity of cylindrical microlenses, wherein the cylindrical microlenses are each arranged on a surface of the lens arrays, wherein image planes of the cylindrical microlenses are arranged on a focal plane within a spacing between the lens arrays.

15. The transmission unit as recited in claim 14, wherein the lens arrays of the optical homogenizer are arranged in such a way that the surfaces provided with the cylindrical microlenses are directed in a direction of the at least one beam source.

16. The transmission unit as recited in claim 14, wherein the lens arrays of the optical homogenizer are arranged in such a way that the surfaces provided with the cylindrical microlenses are directed toward or away from each other.

17. The transmission unit as recited in claim 12, wherein the optical homogenizer includes a lens array with a first surface and a second surface, wherein a multiplicity of cylindrical microlenses is arranged on the first surface and the second surface, wherein image planes of the cylindrical microlenses are arranged between the first surface and the second surface.

18. The transmission unit as recited in claim 17, wherein the image planes of the cylindrical microlenses are arranged centrally between the first surface and the second surface.

19. The transmission unit as recited in claim 14, wherein a number of the cylindrical microlenses and/or a form of the cylindrical microlenses and/or a size of the cylindrical microlenses of the two lens arrays, is configured to be the same as each other or different from each other, and wherein the form of the cylindrical microlenses and/or the size of the cylindrical microlenses within one surface of the lens array is configured to be constant or varying.

20. The transmission unit as recited in claim 12, wherein the transmission optics are configured to form a linear illumination.

21. The transmission unit as recited in claim 12, wherein the at least one beam source is configured as an array of emitters, wherein the emitters are arranged in such a way that the beams generated by the beam source form a rectangular and/or elongate scanning pattern.

22. A LIDAR device for scanning a scanning area, comprising:
a transmission unit including:
at least one beam source configured to generate electromagnetic beams having a linear or rectangular cross section,
transmission optics, and
an optical homogenizer arranged in a beam path of the generated beams in front of or behind the transmission optics, including at least one lens array; and
a receiving unit with at least one detector configured to receive beams reflected and/or back-scattered from the scanning area.
